(19) United States
(12) Patent Application Publication
(10) Pub. No.: US 2019/0289818 A1
(43) Pub. Date: Sep. 26, 2019

(54) Gravity Feeder With Weighted Ball

(71) Applicant: Caleb Smith, Oklahoma City, OK (US)

(72) Inventor: Caleb Smith, Oklahoma City, OK (US)

(21) Appl. No.: 15/926,396

(22) Filed: Mar. 20, 2018

(51) Int. Cl. A01K 5/02

(52) U.S. Cl. CPC A01K 5/0225; B65D 83/06

(57) ABSTRACT

A gravity feeder with a weighted ball includes a hopper having a conical configuration that may be hung from a tree branch. The hopper includes a funnel shaped configuration and defines an open top into which granular feed may be deposited into an interior area of the hopper. A plurality of tubular distribution sections extends from a mouth of the hopper to near the ground for depositing the feed thereon. The gravity feeder includes a heavy spherical ball situated atop the feed in the hopper that pushes the feed downward into the conduit and, in fact, can descend into the distribution sections to ensure the feed is completely deposited.

### BACKGROUND OF THE INVENTION

This invention relates generally to animal feeding devices and, more particularly, to a gravity feeder having a weighted ball to force the complete deposit of granular or powdered feed onto the ground.

Gravity feeders are devices for dispensing granular or powder food material to livestock. Such feeders are known to suffer from incomplete emptying or even become clogged as the feed material may become wet or simply be clumpy from the start. To overcome this problem, some gravity feeders have utilized electric powered agitators to break up the clumps.

Although presumably effective for their desired purposes, the existing products and proposals require external or battery power which may not be available in remote areas or simply be cost prohibitive.

Therefore, it would be desirable to have a gravity feeder with weighted ball that may be hung from a tree branch so as to move in the wind, the gravity feeder including a conical hopper having an open top into which granular feed may be deposited and having a plurality of distribution sections extending from a mouth of the hopper to near the ground for depositing the feed thereon. Further, it would be desirable to have a gravity feeder that includes a heavy ball situated atop the feed in the hopper that pushes the feed downward into the conduit and, in fact, can descend into the conduit to ensure the feed is completely deposited.

### SUMMARY OF THE INVENTION

A gravity feeder apparatus according to the present invention includes a hopper having a continuous side wall having a conical configuration, the continuous side wall having a rim at an upper end thereof and having a mouth at a lower end. The continuous side wall defines an interior area for holding the granular feed. A plurality of distribution sections is operably coupled to the mouth, each distribution section having a tubular configuration having an open top and an open bottom that allows the granular feed to pass therethrough. A spherical weight or weighted ball is positioned atop the granular feed in the hopper, the spherical weight pushing the granular feed downward from the hopper into the plurality of distribution sections.

Therefore, a general object of this invention is to provide a gravity feeder having a hopper for receiving granular feed and having a spherical weight situated atop the granular feed to ensure complete deposit of the granular feed.

Another object of this invention is to provide a gravity feeder, as aforesaid, that may be hung from a tree branch so that a hopper with granular feed may swing freely in the breeze and, thus, spread out deposited feed.

Still another object of this invention is to provide a gravity feeder, as aforesaid, having a plurality of modular distribution sections that may be fastened to a mouth of the hopper so as to be length adjustable relative to the height of mounting to a tree branch.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a gravity feeder with weighted ball according to a preferred embodiment of the present invention;

FIG. 2 is an exploded view of the gravity feeder with weighted ball as in FIG. 1;

FIG. 3 is an isolated view of a hopper according to the present invention illustrated with the lid removed;

FIG. 4 is a top view of the hopper as in FIG. 3;

FIG. 5a is a side view of a distribution section taken from FIG. 1;

FIG. 5b is a sectional view taken along line 5b-5b of FIG. 5a;

FIG. 6a is a side view of an outlet section taken from FIG. 1;

FIG. 6b is a sectional view taken along line 6b-6b of FIG. 6a;

FIG. 7 is an isolated view on an enlarged scale of the weighted ball as in FIG. 2.

### DESCRIPTION OF THE PREFERRED EMBODIMENT

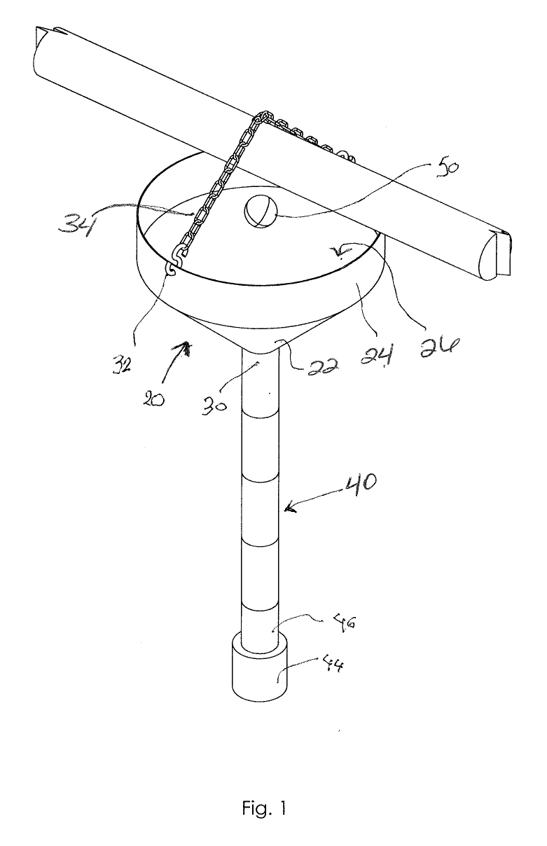

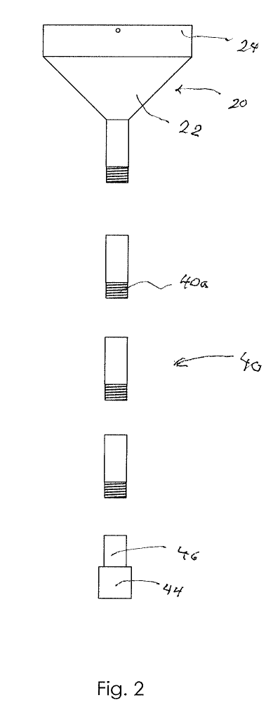

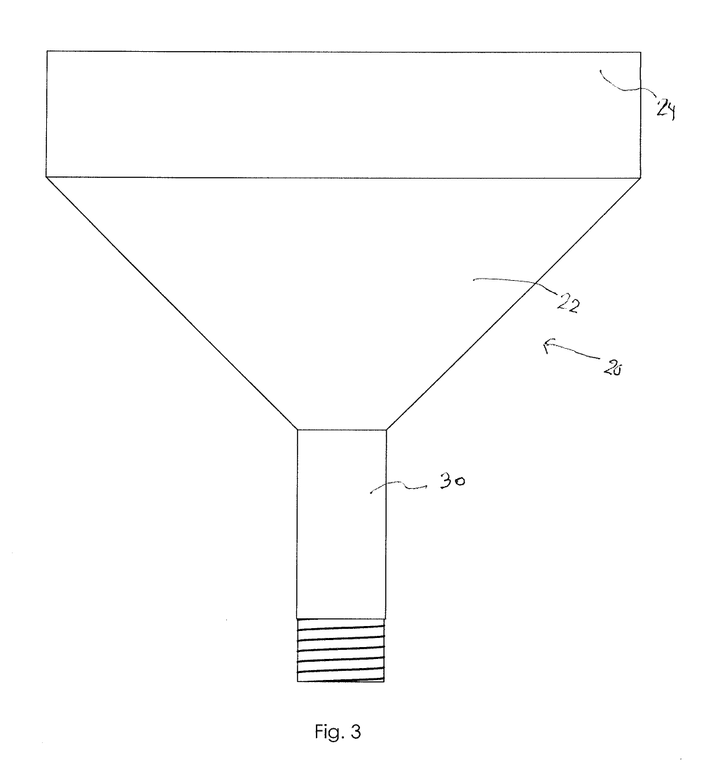

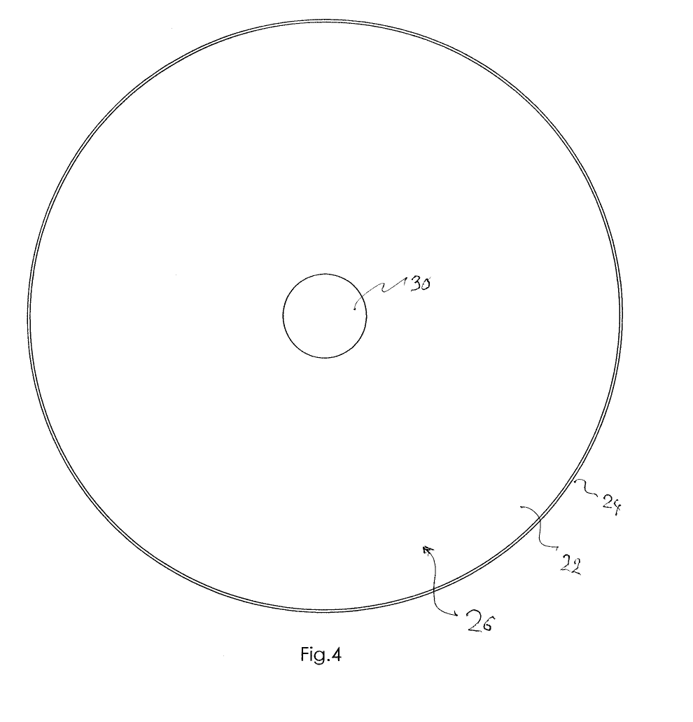

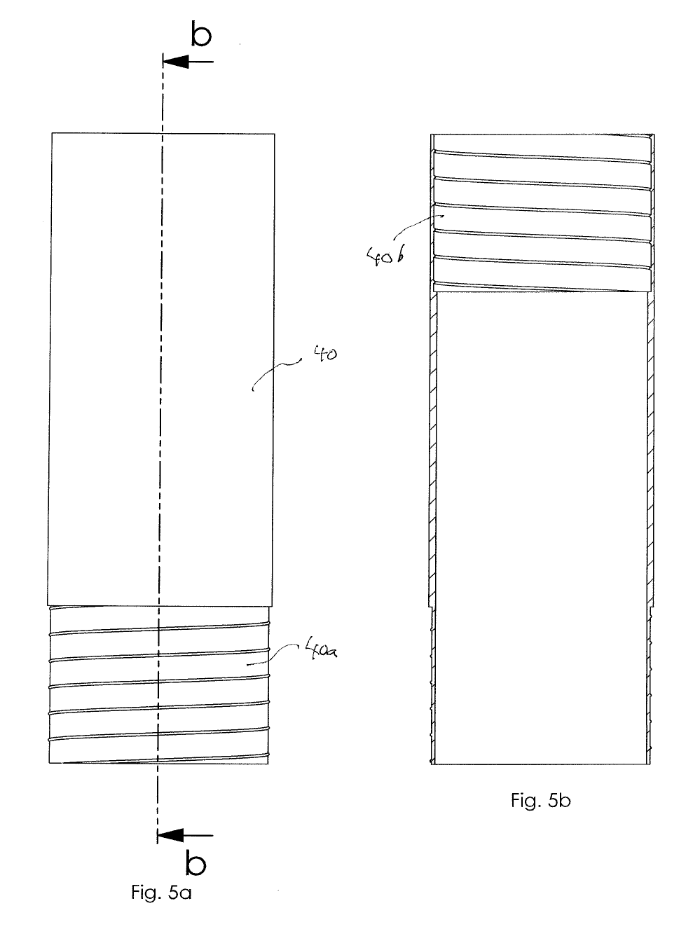

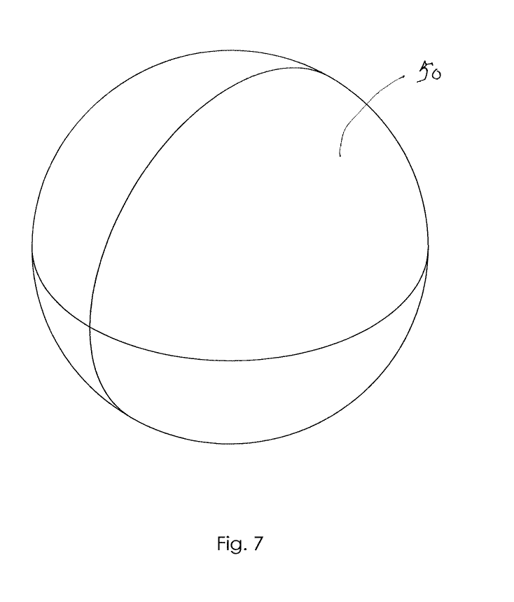

A gravity feeder with weighted ball according to a preferred embodiment of the present invention will now be described in detail with reference to FIGS. 1 to 7 of the accompanying drawings. The gravity feeder 10 with weighted ball includes a hopper 20, a plurality of modular distribution sections 40, and a weighted ball 50.

The hopper 20 includes a continuous side wall 22 having a generally conical or funnel shaped configuration, the hopper 20 defining an interior area and includes an upper rim 24 defining an open top 26 giving access to the interior area of the hopper 20. The hopper 20 includes lower mouth 30 that is open. A lid (not shown) may be selectively mounted atop rim 24 for regulating when the interior area of the hopper 20 may be accessed, such as to insert granular or powdered feed into the hopper 20.

A pair of fasteners 32 may be coupled to the rim 24 of the hopper 20. Alternatively, a pair of extension arms (not shown) extend laterally in opposite directions from an exterior of the side wall of the hopper 20. Then, a mooring member 34, such as a chain or sturdy rope, may be coupled to free ends of the extension arms 32 for securing the hopper 20 to a branch of a tree. It is understood that by hanging from a tree branch, the hopper 20 is free to move side to side and even rotate reciprocally by the natural forces of the wind or as the apparatus is nudged by livestock.

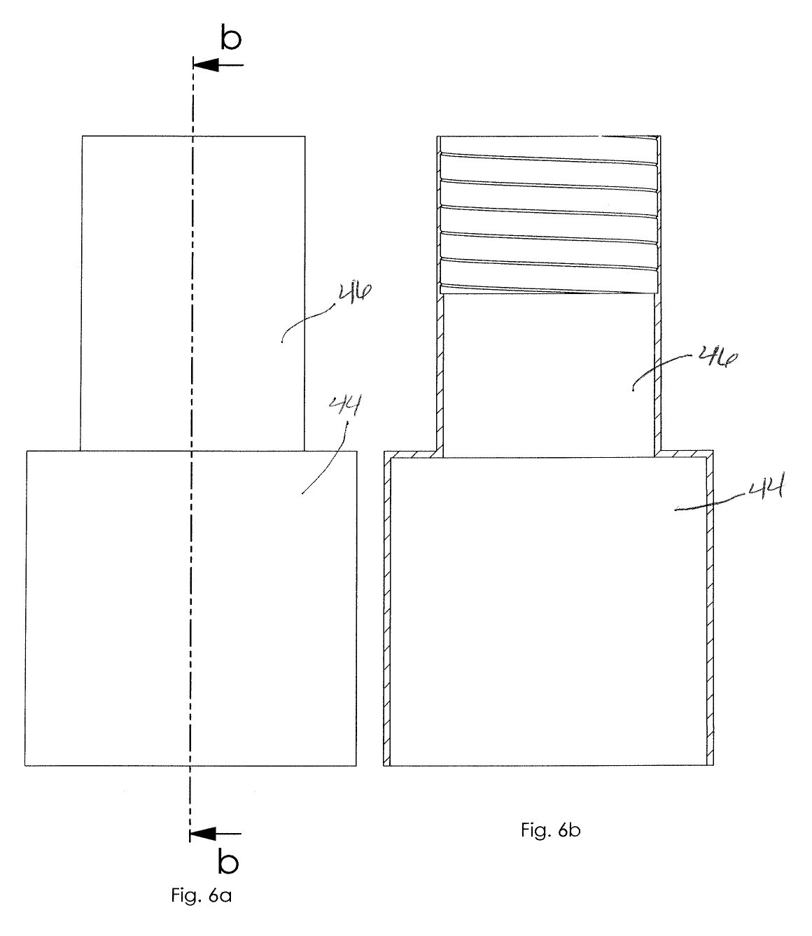

The plurality of distribution sections 40 and specifically an uppermost distribution section, is attached, such as by a threaded friction fit, to the mouth 30 of the hopper 20, such as by a threaded attachment. It is understood that each distribution section 40 may include both an outwardly threaded section 40a and an inwardly threaded section 40b such that the plurality of distribution sections is modular and each may be coupled to a next section. The number of distribution sections 40 may be varied according to how high the branch is, i.e. how far the hopper 20 is situated above the ground. It is preferred that the lowest conduit of the plurality of distribution sections will open very close to the ground so that a strong wind or other weather elements are not allowed to blow the feed away before it would fall to the ground. The lowermost distribution section 42 may also be referred to as an outlet section and has a slightly different configuration (FIGS. 6a and 6b). The outlet section may include an upper portion 46 for attachment to an upwardly adjacent distribution section and a lower portion 44 having a diameter that is larger than a diameter of all other distribution sections so as to deposit granular feed more readily or over a larger surface area of the ground.

To avoid the inherent clogging of existing gravity feeders or incomplete deposition of the granular feed material, the present invention includes a spherical weight or, as will commonly be referred to as a weighted ball 50. The weighted ball 50 has a diameter that is large enough to effectively push the granular feed into the mouth 30 and plurality of distribution sections 40, especially as the hopper 20 is turned by the wind or nudged by livestock. In an embodiment, the weighted ball 50 may have a diameter that allows it to descend into the distribution sections 40 in order to push the feed all the way through the outlet section. The weighted ball 50 may then be retrieved by a user and placed atop the granular feed the next time the hopper 20 is filled.

It is understood that while certain forms of this invention have been illustrated and described, it is not limited thereto except insofar as such limitations are included in the following claims and allowable functional equivalents thereof.

1.-8. (canceled)

9. A gravity feeder apparatus for feeding granular feed to animals, comprising:
a hopper having a continuous side wall having a funnel-shaped configuration, said continuous side wall having a rim at an upper end thereof and having a mouth at a lower end;
wherein said continuous side wall defines an interior area for holding the granular feed;
a plurality of distribution sections operably coupled to said mouth, each distribution section having a tubular configuration having an open top and an open bottom that allows the granular feed to pass therethrough;
wherein said plurality of distribution sections are modular and coupled to one another so as to form a conduit through which the granular feed is passed; and
a spherical weight initially positioned atop the granular feed in said hopper, said spherical weight configured and operable for pushing the granular feed downward from said hopper into said plurality of distribution sections;
an uppermost section coupled to said mouth of said hopper;
a lowermost section having an upper portion coupled to an upwardly adjacent distribution section and a lower portion having an internal diameter that is larger than an internal diameter of all other sections of said plurality of distribution sections; and
a plurality of intermediate sections coupled between said uppermost section and said lowermost section.

10. The gravity feeder apparatus as in claim 9, wherein said spherical weight has a diameter smaller than a diameter of said plurality of distribution sections such that said spherical weight is received by said plurality of distribution sections as the granular feed is pushed therethrough by said spherical weight.

11. The gravity feeder apparatus as in claim 9, wherein:
said rim has an open top;
said mouth has an open bottom;
said rim has a diameter that is larger than a diameter of said mouth such that said continuous side wall has a conical configuration.

12. (canceled)

13. The gravity feeder apparatus as in claim 9, wherein opposed ends of each distribution section of said plurality of distribution sections includes a threaded configuration such that said plurality of distribution sections are selectively threadably coupled together.

14. The gravity feeder apparatus as in claim 9, further comprising a mooring member having an elongate and flexible construction and having a pair of ends operably coupled to opposed sides of said rim, respectively, for hanging said hopper from a branch of a tree.

15. The gravity feeder apparatus as in claim 14, wherein said mooring member is one of a chain or a rope.
